(19) United States
(12) Patent Application Publication
(10) Pub. No.: US 2024/0356878 A1
(43) Pub. Date: Oct. 24, 2024

(54) METHOD, SERVER, AND ELECTRONIC USER TERMINAL COMMUNICATION DEVICES FOR GROUP-BASED ELECTRONIC COMMUNICATIONS IN COMMUNICATION NETWORKS

(71) Applicant: KAKAO CORP., Jeju-si (KR)

(72) Inventors: So Jung PARK, Seongnam-si (KR); Hyun Ju SUNG, Seongnam-si (KR); Hye Jin JEONG, Seongnam-si (KR); Song Won LEE, Seongnam-si (KR)

(21) Appl. No.: 18/601,977

(22) Filed: Mar. 11, 2024

(30) Foreign Application Priority Data
Apr. 21, 2023 (KR) 10-2023-0053004

(51) Int. Cl. H04L 51/046

(52) U.S. Cl. CPC H04L 51/046

(57) ABSTRACT

Disclosed are a system and a method for wired or wireless communications among a group of electronic communication devices such as user terminal devices used by a group of users in a communication network using a network server. The system and method are based on group communications using the network server which provides chat rooms. The system includes a representative electronic user terminal device operated by a representative user and at least one regular user terminal device operated by at least one regular user, which are configured to communicate with each other using the chat rooms.

### BACKGROUND

### Technical Field

The present disclosure relates to a method, server, and user terminal for providing group-based communications among a group of user terminals operated by a group of users through a server which provides a messenger service.

### Description of Related Technology

With the development of mobile communication technology and the proliferation of portable smart devices, messenger services that provide the ability to communicate with others via instant messages, such as text, images, or voice, have become widespread. As a result, messenger services are replacing much of the communication between users that used to take place via voice calls and short message service (SMS).

These messenger services provide users with the ability to connect with each other through a relationship called friends. The messenger service provides other users who are friends with the user as a friend in a friends list. The messenger service also provides services (such as sending gifts and sending money) that are not available to non-friend users.

Also, services have recently emerged that allow a user to set up and manage other users in groups such as family, friends, and romantic relationships, and provide differentiated features for groups. As services based on these groups have become more active, there has been a growing demand for additional new features based on groups.

### SUMMARY

An object of the present disclosure is to provide group-based electronic communications to users of electronic communication devices through a network server which provides a messenger service.

Another object of the present disclosure is to provide a message regarding approval or payment of group-based billing requested by a user of the messenger service through the server, thereby improving user convenience.

Yet another object of the present disclosure is to provide an electronic communication service where a representative user is provided with an approval request message for group-based communications through a chat room of the messenger service and able to input an interaction for approval, thereby facilitating convenient payment.

In another aspect of the present disclosure, there is provided a method for communicating among a plurality of user terminals in a communication network using a server including one or more processors, each of the plurality of user terminals including one or more processors, a transmitter and a receiver. The method includes: identifying, by the server, the plurality of user terminals respectively operated by a group of users comprising a representative user and at least one regular user; obtaining, by the server, authority information of the at least one regular user from a representative terminal operated by the representative user; receiving, by the server, request information from a first terminal operated by a first regular user of the at least one regular user; and transmitting information to the representative terminal through the server based on the obtained authority information of the first regular user.

In one embodiment of the present disclosure, the plurality of user terminals communicate with each other through a chat room provided by the server, in which the representative user and the first regular user participate.

In another embodiment of the present disclosure, the obtaining authority information includes obtaining authority information for group-based billing of the representative user and the at least one regular user participating in the chat room; the receiving request information comprises receiving request information for the group-based billing through the chat room from the first terminal; and the transmitted information to the representative terminal comprises a payment message transmitted through the chat room provided by the server.

In another embodiment of the present disclosure, the chat room is one of a one-on-one chat room in which only the representative user and the first user participate, or the chat room is a group chat room in which another user participates in addition to the representative user and the first regular user.

In another embodiment of the present disclosure, when the authority information of the first regular user allows the group-based billing subject to payment approval of the first regular user by the representative user, the payment message includes an approval request message asking for the payment approval from the representative user, and the approval request message received by the representative terminal includes an approval interface for group-based billing including the first regular user.

In another embodiment of the present disclosure, the method further includes: receiving approval information for the approval request message from the representative terminal; and transmitting a payment completion message for the group-based billing by the first regular user to at least one of the representative terminal and the first terminal.

In another embodiment of the present disclosure, the payment completion message is transmitted through a different chat room than the chat room where the approval request message is provided.

In another embodiment of the present disclosure, when the authority information of the first regular user allows the group-based billing based on pre-approval by the representative user, the payment message includes a payment completion message for the group-based billing by the first regular user, and the payment completion message is provided through the chat room, which provides information on a payment function provided by the server. Further, the representative user and the server performing the payment function participate in the chat room with the first regular user.

In another embodiment of the present disclosure, the obtaining of the authority information includes: providing the representative terminal with an authorization setting interface for setting information regarding the at least one regular user and at least one authority information for each one of the at least one regular user; and receiving setting information for the authorization setting interface from the representative terminal.

In another embodiment of the present disclosure, the authority information includes: information regarding authority for each corresponding one of the at least one regular user to enable the group-based billing subject to approval by the representative user; and information regarding authority for the each corresponding one of the at least one regular user to enable the group-based billing based on pre-approval by the representative user.

In another embodiment of the present disclosure, the authority information includes information regarding a payment limit and a number of payments allowed for the group-based billing by the at least one regular user.

In another embodiment of the present disclosure, the group further includes an additional approver, and when the authority information of the first regular user allows the group-based billing subject to payment approval by at least one of the representative user and the additional approver, the payment message includes an approval request asking for payment approval from at least one of the representative user and the additional approver, and the approval request message is provided through the chat room in which at least one of the representative user and the additional approver participates along with the first regular user.

In another embodiment of the present disclosure, the group-based billing includes at least one payment method, and the receiving of the request information includes: providing a selection interface for selecting one of the at least one payment method for the group-based billing to the first terminal; and receiving information regarding a selection input on the selection interface from the first terminal, and the payment message is generated further based on the payment method selected by the first regular user.

In another aspect of the present disclosure, provided is a method for communicating among a plurality of user terminals configured to be respectively operated by a group of users including a representative user and at least one regular user through a server, wherein the plurality of user terminals includes a representative terminal operated by the representative user, the method including: displaying, on the representative terminal, information regarding the group including the a representative user and the at least one regular user; displaying, on the representative terminal, an authorization setting interface for setting at least one authority information of each one of the at least one regular user; receiving, by the representative terminal, a setting interaction for the authorization setting interface; and displaying, on the representative terminal, information generated in response to a request by a first regular user of the at least one regular user, the generated information being generated as a predetermined type of information based on the authority information of the first regular user.

In another embodiment of the present disclosure, the plurality of user terminals communicate through a chat room provided by the server in which the representative user and the first regular user participate, and the method includes performing group-based billing in the chat room, the request is a payment request for the group-based billing, and the pre-determined type of information includes a payment message.

In another aspect of the present disclosure, provided is a representative terminal configured to be operated by a representative user, and to communicate with at least one regular terminal configured to be operated by at least one regular user through a server in a communication network. The representative terminal includes: a memory storing instructions, and a processor configured to execute the instructions to: display, on the representative terminal, information regarding a group including the representative user and the at least one regular user; display, on the representative terminal, an authorization setting interface for setting at least one authority information of each one of the at least one regular user; receive, by the representative terminal, a setting interaction for the authorization setting interface; and display, on the representative terminal, information generated in response to a request by a first regular user of the at least one regular user, the generated information being generated as a predetermined type of information based on authority information of the first regular user.

In another embodiment of the present disclosure, the terminal is configured to communicate through a chat room provided by the server, the request is a payment request, and the pre-determined type of information includes a payment message.

In another aspect of the present disclosure, there is provided a method for providing group-based billing to users of a messenger service by a server, the method including: identifying a group composed of a plurality of users of the messenger service, the group comprising a representative user and at least one regular user; obtaining authority information for group-based billing of the at least one regular user from a terminal of the representative user; receiving payment request information for the group-based billing from a terminal of a first regular user; and providing a payment-related message to the terminal of the representative user through the messenger service based on authority information of the first regular user.

The payment-related message may be provided through a chat room in which the representative user and the first regular user participate.

When there is an existing chat room, the payment-related message may be provided through the existing chat room.

When the authority information of the first regular user allows the group-based billing subject to payment approval by the representative user, the payment-related message may include an approval request message asking for the payment approval from the representative user.

The approval request message may include an approval interface for group-based billing requested by the first regular user.

The method may further include: receiving approval information for the approval request message from the terminal of the representative user; and providing a payment completion message for the group-based billing by the first regular user to at least one of the terminal of the representative user and the terminal of the first regular user.

The payment completion message may be provided through a different chat room than a chat room where the approval request message is provided.

When the authority information of the first regular user allows the group-based billing based on pre-approval by the representative user, the payment-related message may include a payment completion message for the group-based billing by the first regular user. The payment completion message may be provided through an information providing chat room for providing information on a payment function.

The information providing chat room may be a chat room in which the representative user and a server performing the payment function participate.

The obtaining of the authority information may include: providing the terminal of the representative user with an authorization setting interface for setting information regarding at least one regular user, and at least one authority information for each one of the at least one regular user; and receiving setting information for the authorization setting interface from the terminal of the representative user.

The authority information may include: information on authority for each corresponding one of the at least one regular user to enable the group-based billing subject to approval by the representative user; and information on authority for the each corresponding one of the at least one regular user to enable the group-based billing based on pre-approval by the representative user.

The authority information may include information regarding a payment limit and a number of payments allowed for the group-based billing by the at least one regular user.

The group further may further include an additional approver. When the authority information of the first regular user allows the group-based billing subject to payment approval by at least one of the representative user and the additional approver, the payment-related message may include an approval request asking for payment approval from at least one of the representative user and the additional approver. The approval request message may be provided through a chat room in which at least one of the representative user and the additional approver participates along with the first regular user.

The group-based billing may include at least one payment method. The receiving of the payment request information may include: providing a selection interface for selecting one of the at least one payment method for the group-based billing to the terminal of the first regular user; and receiving information regarding a selection input on the selection interface from the terminal of the first regular user. The payment-related message may be generated further based on the payment method selected by the first regular user.

In another aspect of the present disclosure, there is provided a server for providing group-based billing to users of a messenger service, the server including a memory storing instructions and a processor configured to execute the instructions to: identify a group composed of a plurality of users of the messenger service, the group comprising a representative user and at least one regular user; obtain authority information for group-based billing of the at least one regular user from a terminal of the representative user; receive payment request information for the group-based billing from a terminal of a first regular user; and provide a payment-related message to the terminal of the representative user through the messenger service based on authority information of the first regular user.

In yet another aspect of the present disclosure, there is provided a method for performing group-based billing by a user terminal through a messenger service, the method including: displaying information regarding a group composed of a representative user and at least one regular user, a user of the user terminal corresponding to the representative user; displaying an authorization setting interface for setting at least one authority information of each one of the at least one regular user; receiving a setting interaction for the authorization setting interface; and displaying a payment-related message generated in response to a payment request for the group-based billing by a first regular user, the payment-related message being generated as a predetermined type of message based on authority information of the first regular user.

The payment-related message may be displayed through a chat room in which the user and the first regular user participate.

In yet another aspect of the present disclosure, there is provided a user terminal for performing group-based billing through a messenger service, the user terminal including a memory storing instructions and a processor configured to execute the instructions to: display information regarding a group composed of a representative user and at least one regular user, a user of the user terminal corresponding to the representative user; display an authorization setting interface for setting at least one authority information of each one of the at least one regular user; receive a setting interaction for the authorization setting interface; and display a payment-related message generated in response to a payment request for group-based billing by a first regular user, the payment-related message being generated as a predetermined type of message based on authority information of the first regular user.

### BRIEF DESCRIPTION OF THE DRAWINGS

FIG. 1 is a diagram illustrating an example of a network environment according to an embodiment of the present disclosure.

FIG. 2 is a flowchart for explaining how a server of the present disclosure provides group-based billing to users of a messenger service.

FIG. 3 is a flowchart illustrating a specific method in which operation S250 of FIG. 2 is performed when approval contingent billing authority is granted to a first regular user.

FIG. 4 is a flowchart illustrating a specific method in which operation S250 of FIG. 2 is performed when pre-approval billing authority is granted to the first regular user.

FIGS. 5 to 14 are diagrams exemplarily showing screens in the process of performing group-based billing by a representative user terminal and a first regular user terminal according to embodiments of the present disclosure.

FIG. 15 is a flowchart for explaining how a representative user terminal of the present disclosure performs group-based billing for users of a messenger service.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

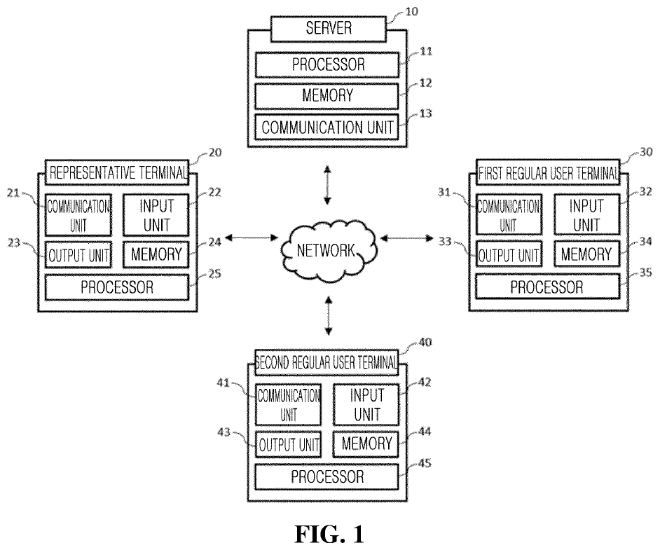

FIG. 1 is a diagram illustrating an example of a network environment according to an embodiment of the present disclosure.

A network environment according to an embodiment of the present disclosure shown in FIG. 1 may include a server 10 and a user terminal. The user terminal may include a representative user's terminal 20 and at least one regular user's terminal. In FIG. 1, a first regular user's terminal 30 and a second regular user's terminal 40 are shown as examples of regular user terminals.

Hereinafter, for the sake of convenience in explanation, the representative user's terminal 20 is referred to as a representative user terminal 20 and a regular user's terminal is referred to as a regular user terminal. Specifically, the first regular user's terminal 30 is referred to as a first regular user terminal 30, and the second regular user's terminal 40 is referred to as a second regular user terminal 40.

Communication schemes for a network are not limited. The communication schemes may include not only a communication scheme to utilize a telecommunication network (for example, a mobile communication network, wired Internet, wireless Internet, and a broadcast network), but also a short-range radio communication scheme.

The server 10 may be implemented as a computer device or a plurality of computer devices that provide commands, codes, files, contents, services, and the like. The server 10 may be a server 10 capable of transmitting and receiving information through communication with a user terminal via a network.

The server 10 may include a processor 11, a memory 12, and a communication unit 13.

The processor 11 may control the overall operation of the memory 12 and the communication unit 13 to provide a messenger service to user terminals. The messenger service provides a conversation (chat) function through instant messages between user terminals.

The memory 12 serves as a storage medium and may store a number of application programs running on the server 10, and data and commands for operation of the server 10. In one embodiment, an application related to the messenger service may be stored in the memory 12.

The memory 12 may be provided in the form of any of various hardware storage devices such as an ROM, an RAM, a flash drive, a hard drive, etc. or may be provided in the form of web storage.

The communication unit 13 may communicate with user terminals in a wired or wireless manner over a network.

The server 10 of the present disclosure may provide the messenger service to user terminals. Specifically, the server 10 provides a message chat room where users can send and receive messages between users as the messenger service. Here, the messages include text, images, video, audio, files, contact information, location information, and participants' voting information.

In the messenger service, users may be connected to each other through a relationship called friendship. In the messenger services, friendships may be formed by users mutually requesting and accepting friendship, or by satisfying conditions such as at least one of two users having the other's phone number stored. In some cases, a messenger service may provide services to users who are not friends, but the types of services provided may be limited compared to those provided to users who are friends.

The server 10 may manage messenger service users by group. Specifically, managing users by group means that the server 10 subordinates the accounts of two or more users to the same group code based on predetermined criteria. A group may be created based on various criteria. For example, a group may be a family account group, an internal account group, an alumni account group, and so on.

Here, the family account group refers to a group that includes two or more users who are in a family relationship with each other. The family relationship may be defined by various criteria such as direct descendants, direct ascendants, collateral relatives, within the fourth degree of relationship, within the sixth degree of relationship, etc.

The server 10 may provide group-based billing to users of the messenger service. The server 10 may identify a group composed of a plurality of users of the messenger service. The group may include a representative user and at least one regular user. The server 10 may receive authorization setting information for group-based billing of the at least one regular user from the representative user terminal 20, and may set authority information for the group-based billing of the at least one regular user based on the authorization setting information. When the server 10 receives payment request information for the group-based billing from the first regular user terminal 30, the server 10 may generate a predetermined type of payment-related message based on the authority information of the first regular user and provide the predetermined type of payment-related message to the representative user terminal 20 through the messenger service.

In this case, the group-based billing refers to a members in the group (including representative users and regular users) making payment using a pre-registered payment method associated with the group. Therefore, using the group-based billing, the member in the group is able to make payment using the payment method that another member of the group has registered. The group-based billing may have conditions set to allow only some members of the group to perform the billing. The payment method of the group-based billing may be a payment method of the representative user, and the representative user may register the payment method with the server 10. The members in the group may share and view the history of payments made through group-based billing by all the members of the group.

In the following, it is described that a regular user requests and performs payment through group-based billing. However, in some cases, a representative user may also request and perform payment through group-based billing.

Here, the representative user is a person designated as a representative of a group. The representative user may have discretion over group-based billing. Specifically, the representative user may set authority information for group-based billing of a regular user and determine whether to approve group-based billing requested by the regular user.

Here, the regular user may be members in the group other than the representative user. The regular user may be granted authority information for group-based billing by the representative user. The regular user may request and proceed with group-based billing based on the authority information for group-based billing.

Here, the authority information may be authority information for group-based billing set for each regular user. The authority for group-based billing may be divided into various types. For example, types of authority may include approval contingent billing authority and pre-approval billing authority.

The approval contingent billing authority refers to the ability to proceed with group-based billing upon approval from the representative user when a regular user requests the group-based billing. In addition, the pre-approval billing authority means that, prior to a regular user requesting group-based billing, the representative user authorizes in advance the regular user's group-based billing, enabling the regular user to proceed with the group-based billing without separate approval from the representative user. When authorizing in advance the group-based billing by the regular user, the representative user may limit the conditions for payment, including the amount and details of the payment.

Here, the payment-related message may be at least one of the following: an approval request message asking for approval for the group-based billing from the representative user, a payment completion message indicating that the group-based billing has been paid, and a payment decline message indicating that the group-based billing has been declined. The payment-related messages may be provided through different types of chat rooms depending on a chat room's type or content. This will be explained in detail below.

User terminals 20, 30, 40 include communication units 21, 31, and 41, input units 22, 32, and 42, output units 23, 33, and 43, memories 24, 34, and 44, and processors 25, 35, and 45, respectively.

Each communication unit 21, 31, or 41 may communicate with the server 10 or other terminals in a wired or wireless manner.

Each input unit 22, 32, or 42 may receive various information through a user's manipulation and input actions. Each input unit 22, 32, or 42 may be a touch screen module, keyboard, mouse, button, camera, stylus, microphone, etc.

Each user terminal 20, 30, or 40 may receive a user's interaction through a corresponding one of the input units 22, 32, and 42. An interaction refers to a user operating an input unit to input information that reflects the user's selection or intention into a user terminal. For example, the interaction may include touching on a touchscreen, clicking with a mouse, typing on a keyboard, providing voice input through a microphone, capturing an image using a camera, recognizing movements through a motion sensor, and the like.

Each output unit 23, 33, or 43 may output various information. Each output unit 23, 33, or 43 may be a display device, a speaker, a vibration generator, a tactile generator, etc. In some cases, each output unit 23, 33, or 43 may be a device (e.g., Bluetooth earphone) that is connected to a corresponding user terminal 20, 30, or 40 through wired or wireless communication (e.g., short-range radio communication such as Bluetooth) to receive and output a signal.

Each memory 24, 34, or 44 serves as a storage medium and may store a plurality of application programs running on a corresponding user terminal 20, 30, or 40, and data and instructions for operating the corresponding user terminals 20, 30, or 40. Each memory 24, 34, or 44 may be provided in the form of any of various hardware storage devices such as an ROM, an RAM, a flash drive, a hard drive, etc. or may be provided in the form of web storage.

In one embodiment, each memory 24, 34, or 44 may store an application associated with performing a messenger service and authentication.

The processors 25, 35, and 45 may execute the application associated with the messenger service by controlling the overall operation of the communication units 21, 31, and 41, the input units 22, 32, and 42, the output units 23, 33, and 43, and the memories 24, 34, and 44.

The representative user terminal 20 may display information regarding a group composed of a representative user and at least one regular user, display an authorization setting interface for setting at least one authority information for each regular user, and receive a setting interaction for the authorization setting interface from the representative user. In addition, when a first regular user requests group-based billing, the representative user terminal 20 may display a payment-related message generated in response to the payment request for the group-based billing. Here, the payment-related message may be generated as a predetermined type of message based on authority information of the first regular user.

The regular user terminal may display an interface for selecting group-based billing as a payment method over a network, such as the Internet, receive an interaction from a regular user selecting group-based billing as the payment method, and request group-based billing from the server 10. In addition, the regular user terminal may display a payment-related message generated in response to a payment request for group-based billing. Here, the payment-related message may be generated as a predetermined type of message based on the authority information of the first regular user.

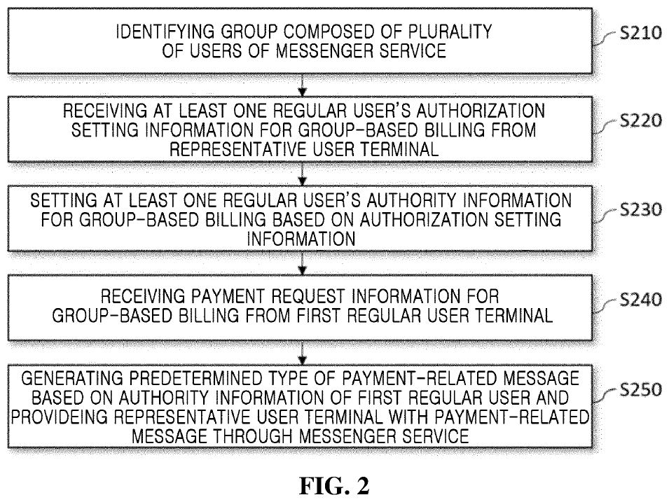

Hereinafter, with reference to FIG. 2, an embodiment of a method in which the server 10 of the present disclosure provides group-based billing to users of a messenger service will be described.

FIG. 2 is a flowchart for explaining how the server 10 of the present disclosure provides group-based billing to users of a messenger service.

In operation S210, the server 10 identifies a group composed of a plurality of users of a messenger service. The server 10 may identify a user's group based on the user's request for the messenger service or the user's condition information. The group may include a representative user and at least one regular user. Hereinafter, for the sake of convenience in the explanation, it will be described that a regular user includes a first regular user and a second regular user. However, the present disclosure may include cases where there is only one regular user and cases where there are three or more regular users.

In operation S220, the server 10 receives authorization setting information for group-based billing of at least one regular user from the representative user terminal 20.

The representative user terminal 20 may receive authorization setting information for group-based billing of at least one regular user and provide the server 10 with the authorization setting information. Specifically, the representative user terminal 20 may display an authorization setting interface for setting at least one authority information for each regular user, and may receive a setting interaction for the authorization setting interface from the representative user. The server 10 may receive the authorization setting information corresponding to the setting interaction input by the representative user.

In some cases, the server 10 may further request and receive from the representative user terminal 20, along with the authorization setting information, authentication information to authenticate the representative user. Here, the authentication information may relate to a certificate that is to be executed in conjunction with the messenger service of the present disclosure.

The authorization setting information is information that sets a regular user's authority information for group-based billing. Specifically, the regular user's authority information for group-based billing may be set, modified, or revoked based on the authorization setting information.

The regular user's authority information for group-based billing may be divided into at least one predetermined type. For example, types of the authority information may include approval contingent billing authority information and pre-approval billing authority information. The authorization setting information may be information on how to set or modify at least one authority information for each regular user.

In operation S230, the server 10 sets at least one regular user's authority information for group-based billing based on the authorization setting information.

The server 10 sets the regular user's authority information for group-based billing based on the authorization setting information received in operation S220. Depending on the setting of the authority information, it may be determined in a later operation whether the regular user is allowed to request group-based billing and whether approval from the representative user is required to proceed with group-based billing.

In operation S240, the server 10 receives payment request information for group-based billing from the first regular user terminal 30.

Here, the first regular user may be a member who is granted authority for group-based billing by the representative user. In this case, the first regular user terminal 30 may display an interface for selecting group-based billing as a payment method over a network such as the Internet, and may receive an interaction from the first regular user to select group-based billing as the payment method. The server 10 may receive payment request information for group-based billing from the first regular user terminal 30 in response to the interaction.

In operation S250, the server 10 generates a predetermined type of payment-related message based on the first regular user's authority information and provides the predetermined type of payment-related message to the representative user terminal 20 through the messenger service.

The server 10 may generate different types of payment-related messages depending on how the first regular user's authority information is set.

For example, if the first regular user's authority information allows approval contingent billing authority, the server 10 may generate an approval request message as a payment-related message. The approval request message may include an approval interface through which the representative user is able to approve group-based billing requested by the first regular user.

In another example, if the first regular user's authority information allows pre-approval billing authority, the server 10 may not generate an approval request message, but proceed with payment immediately based on the pre-approval and generate a payment completion message. The payment completion message may include information regarding group-based billing completed by the first regular user.

A specific method in which a payment-related message according to the two examples described above is provided to the representative user terminal 20 will be described below with additional reference to other drawings.

As such, a payment-related message generated by the server 10 may be provided to the representative user terminal 20 through the messenger service. Specifically, the payment-related message may be provided through a chat room of the messenger service, in which at least one of the representative user and the first regular user participates.

As described above, since a payment-related message is provided to the representative user terminal 20 through the messenger service, it is advantageous that the representative user is able to receive the payment-related message through the messenger service in a way that the representative user has already used and is familiar with, rather than through a separate application or webpage related to group-based billing.

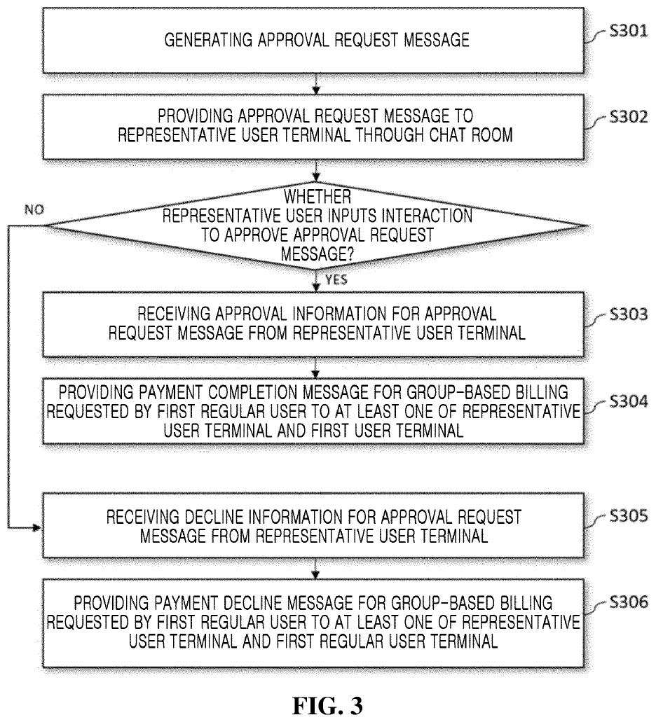

Hereinafter, with reference to FIG. 3, a description will be given of how a payment-related message is provided to the representative user terminal 20 through a messenger service when approval contingent billing authority is granted to the first regular user will be described.

FIG. 3 is a flowchart illustrating a specific method in which operation S250 of FIG. 2 is performed when the approval contingent billing authority is granted to the first regular user.

When the first regular user is granted approval contingent billing authority, a payment-related message may include a primary payment-related message and a secondary payment-related message. The primary payment-related message is an approval request message, and the secondary payment-related message may be either a payment completion message or a payment decline message determined depending on approval. After the primary payment-related message is first provided, the secondary payment-related message may be determined and provided depending on the representative user's approval. Hereinafter, the above-mentioned contents will be described in detail for each operation.

In operation S301, the server 10 may generate an approval request message as the primary payment-related message. The approval request message may include information for group-based billing requested by the first regular user and an approval interface through which the representative user is able to approve the group-based billing requested by the first regular user.

In operation S302, the server 10 provides the approval request message generated in operation S301 to the representative user terminal 20 through a chat room. The chat room may be a chat room in which the representative user and the first regular user participate. This chat room may be a one-on-one chat room in which only the representative user and the first regular user participate or may be a group chat room in which another participant participates in addition to the representative user and the first regular user.

There may be cases where a chat room for delivering an approval request message has already been created and exists. In this case, the server 10 may deliver an approval request message through the existing chat room. For example, suppose that an approval request message is provided through a one-on-one chat room in which the representative user and the first regular user participate, and that the one-on-one chat room exists because the representative user and the first regular user have a history of chatting through the messenger service. In this case, the server 10 may deliver the approval request message through the existing one-on-one chat room.

Chats exchanged between the representative user and the first regular user may be displayed in the one-on-one chat room. If the representative user and the first regular user have already shared the details of group-based billing requested by the first user and the need for approval therefor through the one-on-one chat room, the representative user may easily check the shared details within the same chat room where the approval request message is delivered, without the need of leaving the chat room.

In some cases, after an approval request message is provided through the one-on-one chat room, the representative user and the first regular user may chat about the details of group-based billing requested by the first user and the need for approval therefor through the one-on-one chat room. In such cases, it is advantageous that the representative user and the first regular user are able to chat within the same chat room where the approval request message is delivered, without leaving the chat room.

The representative user may decide whether to approve the group-based billing in response to the approval request message provided in operation S302. Specifically, the representative user may input a result of the decision into the terminal thereof using an interaction for an approval or decline interface included in or connected to the approval request message. Depending on the representative user's decision, either operation S303 or operation S305 may be optionally performed.

When the representative user inputs an interaction to approve the approval request message, operation S303 is performed.

In operation S303, the server 10 receives approval information for the approval request message from the representative user terminal 20.

In some cases, the server 10 may further request and receive from the representative user terminal 20, along with authority information, authentication information to authenticate the representative user. Here, the authentication information may relate to a certificate that is to be executed in conjunction with the messenger service of the present disclosure. Since both the approval request message and the authentication information are provided to the representative user through the messenger service, it is advantageous that the representative user is able to perform various functions for group-based billing at once through the messenger service.

After confirming the approval information, the server 10 proceeds with the group-based billing requested by the first regular user. When the group-based billing requested by the first regular user is successfully completed in operation S303, operation S304 is subsequently performed.

In operation S304, the server 10 provides a payment completion message for the group-based billing requested by the first regular user to at least one of the representative user terminal 20 and the first regular user terminal 30. The payment completion message may correspond to the secondary payment-related message.

The payment completion message may include information for the group-based billing that has been paid and information that the payment has been successfully completed. In some cases, the payment completion message may further include link information to access the history of previous group-based billing for a corresponding group, for example.

This payment completion message may be provided through the same chat room as the aforementioned approval request message or may be provided through a different chat room. If the payment completion message is provided through a different chat room, the different chat room is not a chat room between the representative user and the first regular user, but rather a chat room in which either the representative user or the first regular user, along with the server 10 performing or managing the group-based billing function, participate as speakers. In some cases, the different chat room may not be a chat room where an actual user of the messenger service participates as the chat counterpart, but rather a chat room where the server 10 or a chatbot operated by the server 10 is the chat counterpart. That is, the different chat room may serve primarily as a channel to receive information from the server 10 or the chatbot, rather than facilitating communication between users.

If the payment completion message is provided through a chat room in which the representative user and the first regular user participate, such as an approval request message, the representative user and the first regular user may chat about the payment completion details, etc. through the chat room.

When the representative user inputs an interaction to decline the approval request message, operation S305 is performed.

In operation S305, the server 10 receives decline information for the approval request message from the representative user terminal 20.

After confirming the decline information, the server 10 stops the group-based billing requested by the first regular user. If the group-based billing requested by the first regular user is declined and stopped in operation S305, operation S306 is subsequently performed.

In operation S306, the server 10 provides a payment decline message for the group-based billing requested by the first regular user to at least one of the representative user terminal 20 and the first regular user terminal 30. The payment decline message may correspond to the secondary payment-related message.

The payment decline message may include information for the group-based billing that has been declined and information on the reason for the decline (e.g., decline of approval by the representative user). In some cases, the payment decline message may further include link information to access the history of previous group-based billing for a corresponding group, for example.

This payment decline message may be provided in the same manner as the payment completion messages described above, either through the same chat room where the approval request message is provided or through a different chat room. Since a method for providing a payment decline message through a chat room is very similar to the above-described method for providing a payment completion message, a detailed description thereof will be omitted.

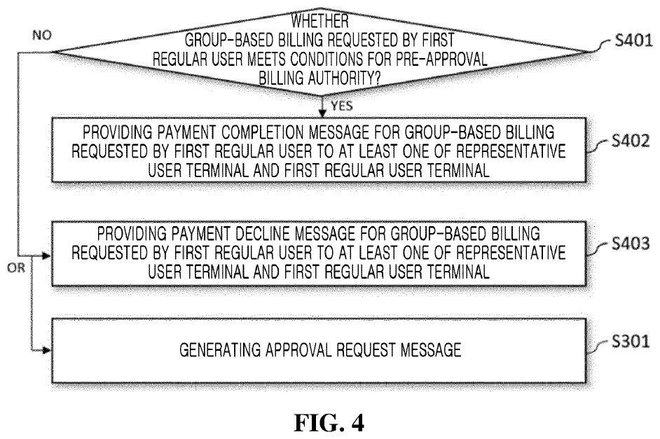

Hereinafter, with reference to FIG. 4, a description will be given of how a payment-related message is provided to a representative user terminal 20 through a messenger service when a first regular user is granted pre-approval billing authority will be described.

FIG. 4 is a flowchart illustrating a specific method in which operation S250 of FIG. 2 is performed when pre-approval billing authority is granted to the first regular user.

When the first regular user is granted pre-approval billing authority, a payment-related message may be a payment completion message or a payment decline message depending on whether group-based billing requested by the first regular user meets the conditions for pre-approval billing authority.

In operation S401, the server 10 determines whether the group-based billing requested by the first regular user meets the conditions for pre-approval billing authority. While inputting authorization setting information for group-based billing of the first regular user, the representative user may add conditions for pre-approval billing by the first regular user. For example, the conditions for pre-approval billing may include a one-time payment amount limit, a total payment amount limit for a predetermined period (e.g., one month), a limit on the number of payments within a predetermined period, and restrictions on payment content.

In operation S401, either operation S402 or operation S403 may be optionally performed, depending on a result of the determination by the server 10.

When the server 10 determines in operation S401 that the group-based billing requested by the first regular user meets the conditions for pre-approval billing authority, operation S402 is performed.

In operation S402, the server 10 provides a payment completion message for the group-based billing requested by the first regular user to at least one of the representative user terminal 20 and the first regular user terminal 30.

The contents of the payment completion message and the method for providing the payment completion message in operation S402 are substantially the same as those of the above-described operation S304. For the sake of convenience in the explanation, a detailed description of operation S402 will be omitted.

When the server 10 determines in operation S401 that the group-based billing requested by the first regular user does not meet the conditions for pre-approval billing authority, operation S403 or operation S301 shown in FIG. 3 is performed. Which of operation S403 and operation S301 is performed may vary depending on service policies stored on the server 10 or settings on the representative user terminal 20.

When operation S403 is performed, the server 10 provides a payment decline message for the group-based billing requested by the first regular user to at least one of the representative user terminal 20 and the first regular user terminal 30.

The payment decline message may include information for the group-based billing that has been declined and information on the reason for the decline (a failure to meet the conditions for pre-approval billing authority, etc.). In some cases, the payment decline message may further include link information to access the history of previous group-based billing for a corresponding group, for example.

The method for providing the payment decline message in operation S403 is substantially the same as the operation S306 described above. For the sake of convenience in the explanation, a detailed description of operation S403 will be omitted.

Unlike operation S403, even if it is determined that the group-based billing requested by the first regular user does not meet the conditions for pre-approval billing authority, the billing may not be declined immediately, but may instead be referred to the representative user for approval. In this case, operation S301 may be performed, and then operations S302 to S306 described with reference to FIG. 3 may be performed subsequently.

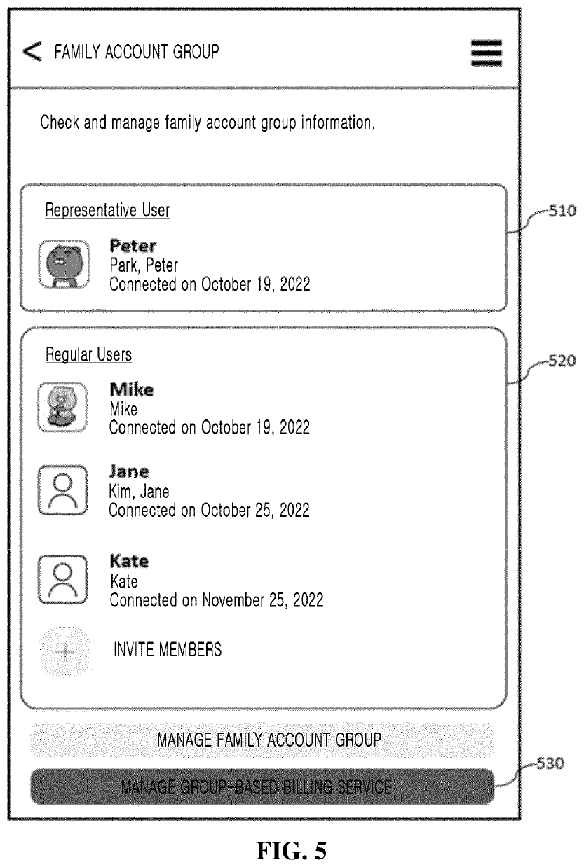

Hereinafter, with reference to FIGS. 5 to 12, an example of a method in which the server 10 described with reference to FIGS. 2 to 4 provides group-based billing to users of a messenger service will be described.

FIGS. 5 to 12 exemplarily show screens in the process of performing group-based billing by the representative user terminal 20 and the first regular user terminal 30 according to embodiments of the present disclosure.

FIG. 5 shows a screen in which the server 10 performs operation S210 of FIG. 2 and the representative user terminal 20 displays relevant information received from the server 10.

Referring to FIG. 5, the representative user terminal 20 displays information regarding a group of messenger users. The information regarding the group may include information regarding the users included in the group. Specifically, the representative user terminal 20 may display information regarding a representative user 510 and information regarding regular users 520 as the information regarding the group. Although not shown in FIG. 5, the representative user terminal 20 may display authority information for group-based billing of the users in the group, along with the information regarding the group.

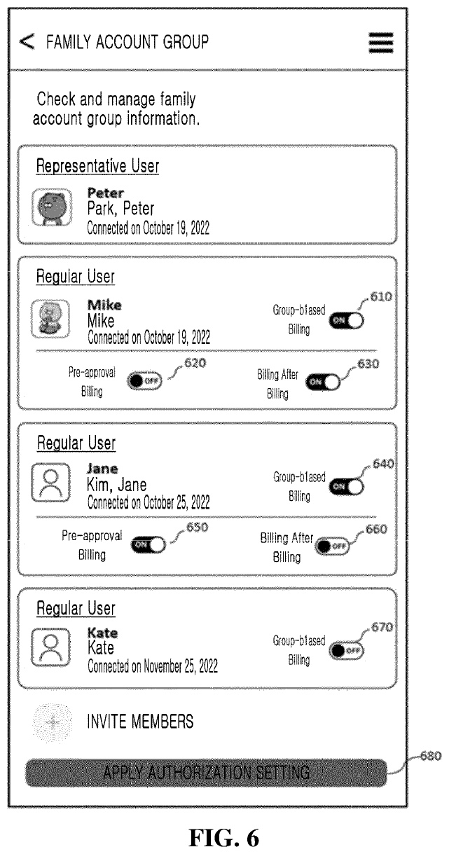

In addition, the representative user terminal 20 may display an interface 530 to link to a page for setting authority information for group-based billing of the users in the group. When the representative user inputs an interaction for the interface 530, a screen as shown in FIG. 6 may be displayed.

FIG. 6 shows a screen in which the representative user terminal 20 is able to input authorization setting information for group-based billing, displayed prior to operation S220, in order for the server 10 to perform operation S220 of FIG. 2.

Referring to FIG. 6, the representative user terminal 20 may display authorization setting interfaces 610 to 680 for setting at least one authority information for each regular user.

The authority information to be set by the representative user may be displayed in multiple types. The types of authority information may be configured hierarchically. In other words, if the representative user primarily approves group-based billing by a specific user, the specific user may secondarily select a specific billing authority. The specific billing authority may include pre-approval billing (pre-approved billing) authority and approval contingent billing (billing after approval) authority.

The pre-approval billing (pre-approved billing) authority refers to a scheme in which the representative user authorizes a regular user in advance so that the regular user can make payment immediately using a registered payment method. In addition, the approval contingent billing (billing after approval) authority refers to a scheme in which the representative user approves a payment request sent by a regular user to proceed with the payment.

Specifically, when the representative user inputs ON interactions 610 and 640 for group-based billing interfaces 610 and 640, interfaces 620, 630, 650, and 660 for determining users' specific billing authority may be displayed. If the representative user inputs an OFF interaction for the group-based billing interface 670, an interface for determining the user's specific billing authority may not be displayed.

When the representative user inputs interactions for the billing authorization setting interfaces 610 to 670, the authorization setting information that modifies the status of each corresponding user's billing authority may be transmitted to the server 10.

Although not shown in FIG. 6, when the representative user allows pre-approval (pre-approved) billing authority, the representative user terminal 20 may further display an interface through which the representative user terminal 20 is able to input conditions for pre-approval for a regular user. In addition, when the representative user terminal 20 does not display a separate interface for inputting conditions for pre-approval (pre-approved), this may indicate that the conditions for pre-approval are set by default as predetermined. When the representative user inputs an interaction for the application authority information setting interface 680 of FIG. 6, the server 10 receives authorization setting information for group-based billing in operation S220 and sets authority information for group-based billing in operation S230.

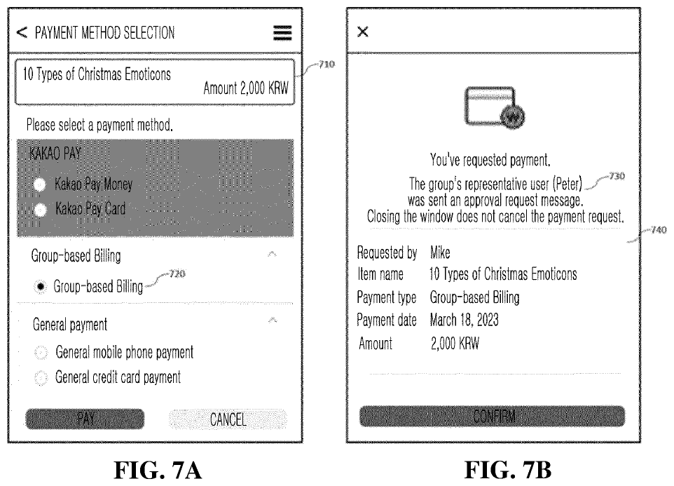

FIGS. 7A-7B show screens in which the first regular user terminal 30 is able to select payment request information for group-based billing, displayed prior to operation S240, in order for the server 10 to perform operation S240 of FIG. 2.

Referring to FIG. 7A, the first regular user terminal 30 may display information 710 on an item to be paid for and at least one selectable payment method. The first regular user may input an interaction for a group-based billing interface 720 among at least one payment method displayed.

Unlike FIG. 7A, if the first regular user does not have billing authority for group-based billing, group-based billing may not be displayed as a selectable payment method. Cases where a specific user does not have billing authority for group-based billing may include, for example, a case where billing authority is not granted by the representative user or a case where the specific user is not included in a corresponding group. In some cases, if the first regular user is included in the group but is not granted billing authority by the representative user, information for group-based billing may be displayed as a selectable payment method but in a disabled state, indicating that the payment can't be made due to the lack of billing authority. In addition, an interface (not shown) to request billing authority from the representative user may be displayed.

In FIG. 7A, when the first regular user inputs an interaction for the group-based billing interface 720, a screen to be subsequently displayed may vary depending on the first regular user's authority information for group-based billing.

When the first regular user's authority information for group-based billing allows approval contingent billing authority, a screen as shown in FIG. 7B may be displayed after the first regular user inputs an interaction for the group-based billing interface 720 in (a) of FIG. 7. Referring to FIG. 7B, a screen may include information 730 indicating that an approval request message has been sent to the representative user of the group, and information 740 regarding group-based billing for which the first regular user has requested approval.

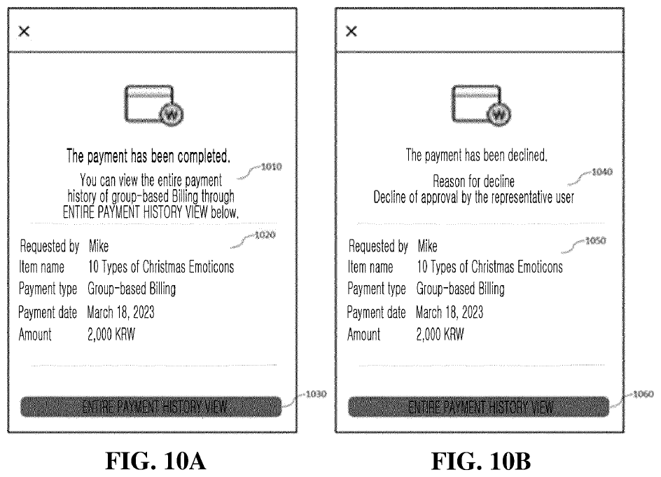

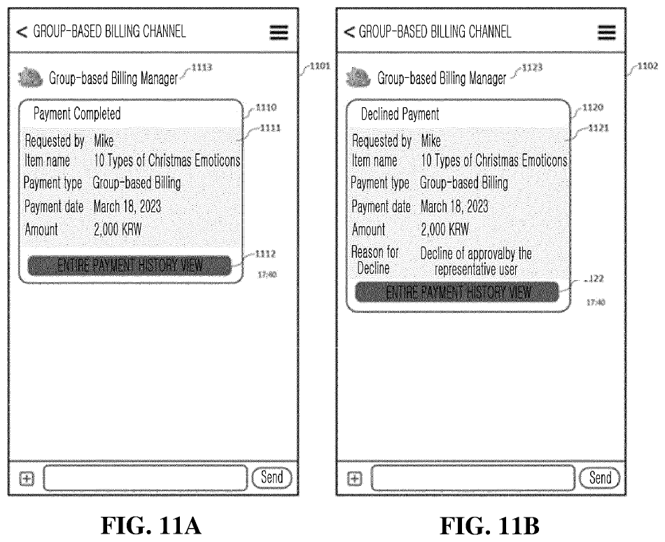

If the first regular user's authority information for group-based billing allows pre-approval billing authority, after the first regular user inputs an interaction for the group-based billing interface 720 in FIG. 7A, a screen similar to that of FIG. 10 or 11 may be displayed or certain contents on the screen may be altered based on a situation.

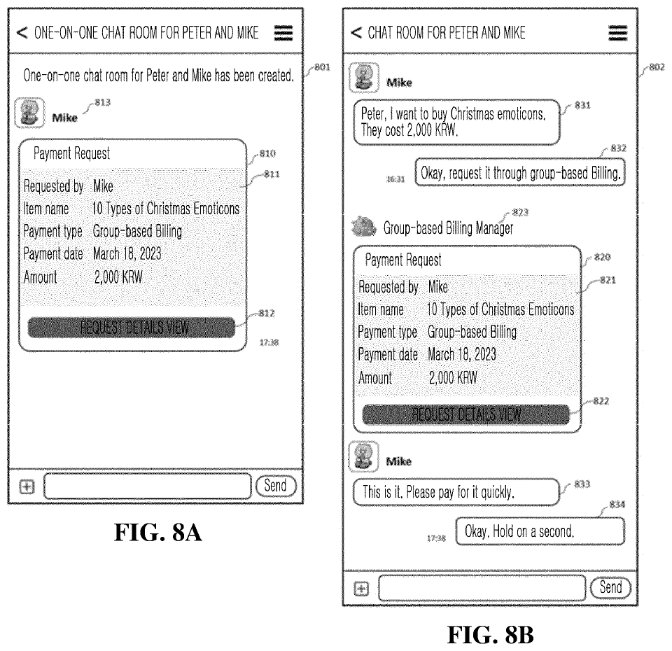

FIGS. 8 to 12 show screens in which the server 10 performs operation S250 of FIG. 2, and at least one of the representative user terminal 20 and the first regular user terminal 30 displays a payment-related message received from the server 10. For the sake of convenience in the explanation, it will be described assuming that FIGS. 8 to 12 are all screens displayed by the representative user terminal 20. However, in FIGS. 8 through 12, a similar screen may be displayed on terminals of regular users in a group, either uniformly or with some contents modified based on the regular users' authority.

FIGS. 8A-8B show screens in which the server 10 performs operations S301 and S302 of FIG. 3 and the representative user terminal 20 displays a payment-related message received from the server 10.

FIGS. 8A-8B show screens in which the server 10 generates an approval request message as a primary payment-related message and provides the approval request message to the representative user terminal 20 when the first regular user requesting the group-based payment is granted approval contingent billing authority based on the first regular user's authority information for group-based billing.

Referring to FIGS. 8A-8B, an approval request message 810 or 820 may be provided through a chat room 801 or 802 of a messenger service, in which at least one of the representative user and the first regular user participates. Specifically, as shown in FIGS. 8A-8B, a chat room may be the one-on-one chat room 801 or 802 in which only the representative user and the first regular user participate.

As shown in FIG. 8A, when there is no existing chat room for delivering an approval request message, a new chat room 801 may be created to provide the approval request message 810. The approval request message 810 may include information 811 regarding group-based billing requested by the first regular user and a request details view interface 812. Although not shown in FIG. 8A, chatting between the representative user and the first regular user may be conducted through the chat room 801.

As shown in FIG. 8B, when there is an existing chat room for delivering an approval request message, the approval request message 820 may be provided through the existing chat room 802. The approval request message 820 may include information 821 regarding group-based billing requested by the first regular user and a request details view interface 822.

In the case of FIG. 8B, since the chat room 802 already exists, the history of chats 831 and 832 between the representative user and the first regular user in the chat room 802 may be displayed before the approval request message 820 is displayed. In addition, after the approval request message 820 is displayed, chats 833 and 834 between the representative user and the first regular user may be made through the chat room 802.

Through the chat rooms 801 and 802, the representative user and the first regular user may discuss group-based billing requested by the first regular user. In this case, the representative user and the first regular user are able to chat within the same chat room 801 or 802 where the approval request message 810 or 820 is delivered, without the need of leaving the chat room 801 or 802.

The approval request message 810 may be displayed in the chat room 801 where the first regular user is a speaker 813, as shown in FIG. 8A. However, in some cases, the approval request message 820 may be presented in a form where the server 10 performing or managing a group-based billing function is a speaker 823, as shown in (b) of FIG. 8.

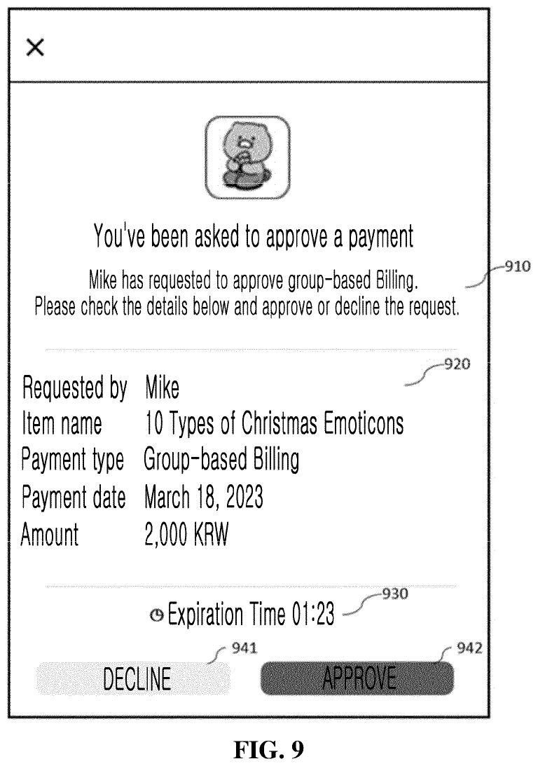

In FIGS. 8A-8B, when the representative user inputs an interaction for the request details view interface 812 or 822 in the approval request message 810 or 820, the screen of FIG. 9 may be displayed.

FIG. 9 shows a detailed view screen of an approval request message generated by the server 10 in operation S301 of FIG. 3 and provided to the representative user terminal 20 in operation S302.

Referring to FIG. 9, the detailed view screen of the approval request message may include: information 910 requesting approval for the group-based billing by the first regular user; details 920 of the group-based billing requested by the first regular user; information 930 regarding an expiration time for the representative user to approve; and interfaces 941 and 942 for approval and decline.

Although not shown in FIG. 9, when the representative user inputs an interaction for the decline interface 941 to decline the group-based billing requested by the first regular user, an interface for inputting the reason for the decline may be displayed.

When the representative user inputs an interaction for the approval interface 942 to approve the group-based billing requested by the first regular user, at least one screen of FIGS. 10 and 11 may be displayed on the representative user terminal 20.

FIGS. 10A, 10B and 11A, 11B show screens where a payment completion message and a payment decline message provided by the server 10 in operation S304, S306, S402, or S403 of FIGS. 3 and 4 are displayed.

Referring to FIG. 10A, a payment completion message may be displayed. The payment completion message may include payment completion information 1010 for the group-based billing, details 1020 of the group-based billing that has been paid, and an interface 1030 for viewing the entire payment history of group-based billing.

Referring to FIG. 10B, a payment decline message may be displayed. The payment decline message may include payment decline information 1040 for the group-based billing, details 1050 of the group-based billing that has been declined, and an interface 1060 for viewing the entire payment history of group-based billing.

Referring to FIGS. 11A and 11B, a payment completion message may be provided through a chat room 1101 or 1102 for providing information, rather than a chat room in which the representative user and the first regular user participate.

The chat room 1101 or 1102 of FIGS. 11A and 11B may display a payment-related message in which the server 10 performing or managing a group-based billing function is a speaker 1113 or 1123. In some cases, the chat room 1101 or 1102 is a chat room where the server 10 or a chatbot operated by the server 10 is a chat counterpart 1113 or 1123, and may serve primarily as a channel to receive information from the server 10 or the chatbot, rather than facilitating communication between users. Therefore, in this type of chat room 1101 or 1102, the representative user may be restricted from typing messages.

Referring to FIG. 11A, a payment completion message 1110 may be displayed. The payment completion message 1110 may include details 1111 of group-based billing that has been paid, and an interface 1112 for viewing the entire payment history of group-based billing.

Referring to FIG. 11B, a payment decline message 1120 may be displayed. The payment decline message 1120 may include details 1121 of group-based billing that has been declined, and an interface 1122 for viewing the entire payment history of group-based billing.

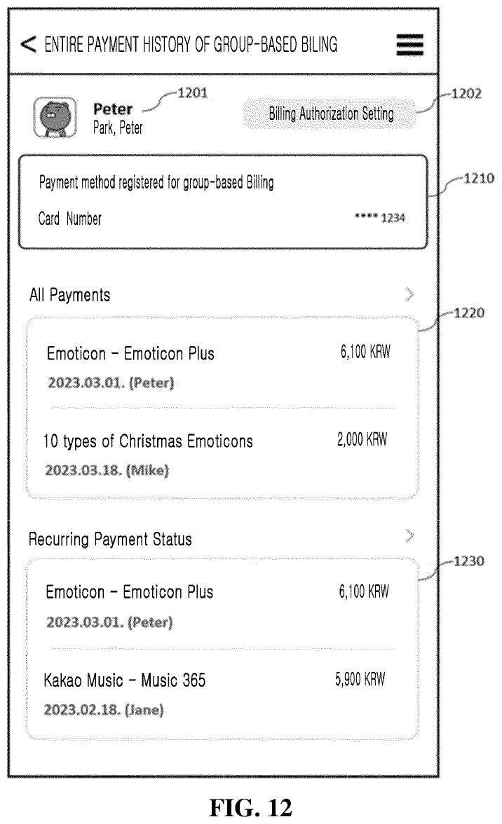

When the representative user inputs an interaction for the interface 1030, 1060, 1112, or 1122 to view the entire payment history of group-based billing, a screen showing the entire payment history of group-based billing shown in FIG. 12 may be displayed.

FIG. 12 shows a screen displaying the entire details of group-based billing displayed by the representative user terminal 20.

Referring to FIG. 12, various information regarding group-based billing may be displayed. Specifically, information 1201 regarding a user, an interface 1202 for setting a group member's billing authority for group-based billing, information 1220 regarding the entire payment history of group-based billing, and information 1230 regarding the recurring payment status of group-based billing may be displayed.

In some cases, the information regarding group-based billing as shown in FIG. 12 may be accessible not only to the representative user but also to a regular user. When the information regarding group-based billing as shown in FIG. 12 is displayed on a regular user terminal, the information 1201 regarding the user may be changed to information on the corresponding regular user of the regular user terminal, and the interface 1202 for setting a group member's billing authority for group-based billing may be deactivated or changed to a different interface. For example, the interface 1202 for setting billing authority may be changed to an interface (not shown) for requesting the representative user to modify a requester's authority information.

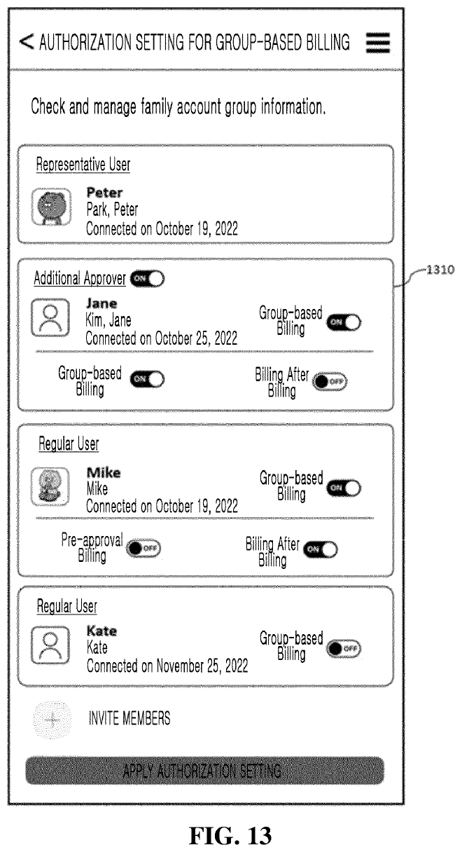

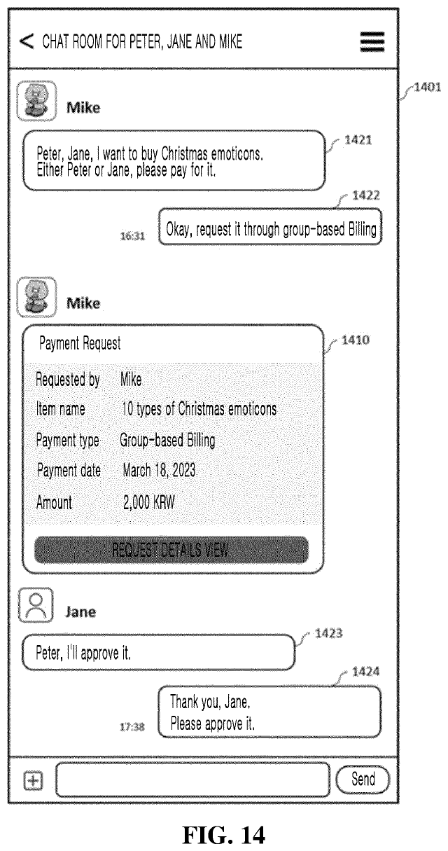

Hereinafter, another embodiment of a method in which the server 10 of the present disclosure provides group-based billing to users of a messenger service will be described with reference to FIGS. 13 and 14.

FIGS. 13 and 14 exemplarily show screens in the process of performing group-based billing by a representative user terminal 20 according to another embodiment of the present disclosure.

Referring to FIG. 13, information 1310 regarding an additional approver, who, besides the representative user, has the authority to approve group-based billing, may be presented. The additional approver may be designated by the representative user. An interface may be displayed, allowing the representative user to designate the additional approver.

The approval authority of the additional approver may be defined in various ways. For example, whether either the representative user or the additional approver approves an approval request for group-based billing, the approval for the group-based billing may be completed. However, in some cases, both the representative user and additional approvers may need to approve the approval request for group-based billing in order to complete the approval for that group-based billing.

In some cases, the approval authority of the additional approver may be determined depending on the amount or payment details of group-based billing. For example, if the amount of group-based billing is equal to or less than 100,000 KRW, it may be determined that the additional approver has sole approval authority, but if the amount exceeds 100,000 KRW, it may be determined that the additional approver has no sole approval authority.

Referring to FIG. 14, when there is a designated additional approver, an approval request message 1410 may be provided through a chat room 1401 where a representative user, an additional approver, and a first regular user participate. If there is an existing chat room 1401, the approval request message 1410 may be provided through the existing chat room. On the other hand, if there is no existing chat room, a new chat room may be created to provide the approval request message 1410.

As shown in FIG. 14, when the additional approver has the approval authority for the approval request message 1410, the group-based billing may be approved solely through the corresponding chat room 1401.

As shown in FIG. 14, the representative user, the additional approver, and the first regular user may engage in chats 1421 to 1424 regarding group-based billing through a chat room 1401 in which the approval request message 1410 is provided.

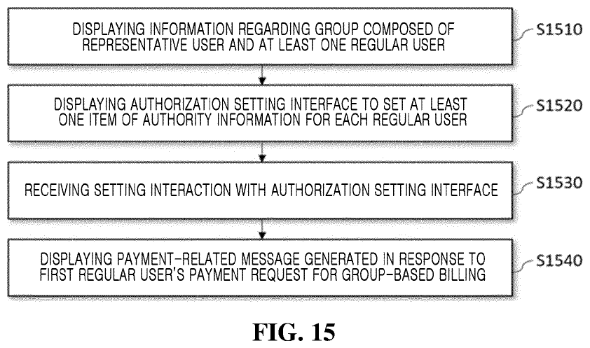

Hereinafter, with reference to FIG. 15, a description will be given of how a representative user terminal 20 of the present disclosure performs group-based billing for users of a messenger service.

FIG. 15 is a flowchart for explaining how the representative user terminal 20 of the present disclosure performs group-based billing for users of a messenger service.

The method in which the representative user terminal 20 facilitates group-based billing is similar to that of the server 10 providing group-based billing, as described in FIG. 2 to FIG. 12, with the sole distinction being the entity performing the process, while the substantive content remains the same. Therefore, for the sake of convenience in the explanation, some of the content regarding the method in which the representative user terminal 20 performs group-based billing will be overlapped with the aforementioned content.

In operation S1510, the representative user terminal 20 displays information regarding a group composed of a representative user and at least one regular user. Operation S1510 corresponds to operation S210 performed by the server 10. An example screen of the representative user terminal 20 in operation S1510 is shown in FIG. 5.

In operation S1520, the representative user terminal 20 displays an authorization setting interface for setting at least one item of authority information for each regular user. In operation S1530, the representative user terminal 20 receives a setting interaction for the authorization setting interface. Operations S1520 and S1530 correspond to operations S220 and S230 performed by the server 10. Example screens of the representative user terminal 20 in operations S1520 and S1530 are shown in FIG. 6.

In operation S1540, the representative user terminal 20 displays a payment-related message generated in response to a payment request for group-based billing by the first regular user. Operation S1540 corresponds to operation S250 performed by the server 10. Example screens of the representative user terminal 20 in operation S1510 are shown in FIGS. 8 to 12.

According to the present disclosure, it is possible to provide group-based billing to users of a messenger service.

According to the present disclosure, it is possible to provide a message regarding approval or payment of group-based billing requested by a user of a messenger service, thereby enhancing user convenience.

According to the present disclosure, it is possible for a representative user to receive an approval request message for group-based billing through a chat room of the messenger service and to input approval information, thereby facilitating payment conveniently.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for communicating among a plurality of user terminals in a communication network using a server including one or more processors, each of the plurality of user terminals including one or more processors, a transmitter and a receiver, the method comprising:
identifying, by the server, the plurality of user terminals respectively operated by a group of users comprising a representative user and at least one regular user;
obtaining, by the server, authority information of the at least one regular user from a representative terminal operated by the representative user;
receiving, by the server, request information from a first terminal operated by a first regular user of the at least one regular user; and
transmitting information to the representative terminal through the server based on the obtained authority information of the first regular user.

2. The method of claim 1, wherein the plurality of user terminals communicate with each other through a chat room provided by the server, in which the representative user and the first regular user participate.

3. The method of claim 2, wherein:
the obtaining authority information comprises obtaining authority information for group-based billing of the representative user and the at least one regular user participating in the chat room;
the receiving request information comprises receiving request information for the group-based billing through the chat room from the first terminal; and
the transmitted information to the representative terminal comprises a payment message transmitted through the chat room provided by the server.

4. The method of claim 3, wherein the chat room is one of a one-on-one chat room in which only the representative user and the first user participate, or the chat room is a group chat room in which another user participates in addition to the representative user and the first regular user.

5. The method of claim 3, wherein, when the authority information of the first regular user allows the group-based billing subject to payment approval of the first regular user by the representative user, the payment message comprises an approval request message asking for the payment approval from the representative user.

6. The method of claim 5, wherein the approval request message received by the representative terminal comprises an approval interface for group-based billing including the first regular user.

7. The method of claim 5, further comprising:
receiving approval information for the approval request message from the representative terminal; and
transmitting a payment completion message for the group-based billing by the first regular user to at least one of the representative terminal and the first terminal.

8. The method of claim 7, wherein the payment completion message is transmitted through a different chat room than the chat room where the approval request message is provided.

9. The method of claim 3, wherein, when the authority information of the first regular user allows the group-based billing based on pre-approval by the representative user, the payment message comprises a payment completion message for the group-based billing by the first regular user, and
wherein the payment completion message is provided through the chat room, which provides information on a payment function provided by the server.

10. The method of claim 9, wherein the representative user and the server performing the payment function participate in the chat room with the first regular user.

11. The method of claim 3, wherein the obtaining of the authority information comprises:
providing the representative terminal with an authorization setting interface for setting information regarding the at least one regular user and at least one authority information for each one of the at least one regular user; and
receiving setting information for the authorization setting interface from the representative terminal.

12. The method of claim 11, wherein the authority information comprises:
information regarding authority for each corresponding one of the at least one regular user to enable the group-based billing subject to approval by the representative user; and
information regarding authority for the each corresponding one of the at least one regular user to enable the group-based billing based on pre-approval by the representative user.

13. The method of claim 11, wherein the authority information comprises information regarding a payment limit and a number of payments allowed for the group-based billing by the at least one regular user.

14. The method of claim 3,
wherein the group further comprises an additional approver,
wherein, when the authority information of the first regular user allows the group-based billing subject to payment approval by at least one of the representative user and the additional approver, the payment message comprises an approval request asking for payment approval from at least one of the representative user and the additional approver, and
wherein the approval request message is provided through the chat room in which at least one of the representative user and the additional approver participates along with the first regular user.

15. The method of claim 3,
wherein the group-based billing comprises at least one payment method,
wherein the receiving of the request information comprises:
providing a selection interface for selecting one of the at least one payment method for the group-based billing to the first terminal; and
receiving information regarding a selection input on the selection interface from the first terminal, and
wherein the payment message is generated further based on the payment method selected by the first regular user.

16. A method for communicating among a plurality of user terminals configured to be respectively operated by a group of users including a representative user and at least one regular user through a server, wherein the plurality of user terminals includes a representative terminal operated by the representative user, the method comprising:
displaying, on the representative terminal, information regarding the group including the representative user and the at least one regular user;
displaying, on the representative terminal, an authorization setting interface for setting at least one authority information of each one of the at least one regular user;
receiving, by the representative terminal, a setting interaction for the authorization setting interface; and
displaying, on the representative terminal, information generated in response to a request by a first regular user of the at least one regular user, the generated information being generated as a predetermined type of information based on the authority information of the first regular user.

17. The method of claim 16, wherein:
the plurality of user terminals communicate through a chat room provided by the server in which the representative user and the first regular user participate;
the method comprises performing group-based billing in the chat room;
the request is a payment request for the group-based billing, and
the pre-determined type of information comprises a payment message.

18. A representative terminal configured to be operated by a representative user, and to communicate with at least one regular terminal configured to be operated by at least one regular user through a server in a communication network, the representative terminal comprising:
a memory storing instructions, and
a processor configured to execute the instructions to:
display, on the representative terminal, information regarding a group including the representative user and the at least one regular user;
display, on the representative terminal, an authorization setting interface for setting at least one authority information of each one of the at least one regular user;
receive, by the representative terminal, a setting interaction for the authorization setting interface; and
display, on the representative terminal, information generated in response to a request by a first regular user of the at least one regular user, the generated information being generated as a predetermined type of information based on authority information of the first regular user.

19. The representative terminal of claim 18, wherein the terminal is configured to communicate through a chat room provided by the server, the request is a payment request, and the pre-determined type of information includes a payment message.
